(19) United States
(12) Patent Application Publication
(10) Pub. No.: US 2016/0034730 A1
(43) Pub. Date: Feb. 4, 2016

(54) ASSET LOCATION ON CONSTRUCTION SITE

(71) Applicant: Trimble Navigation Limited, Sunnyvale, CA (US)

(72) Inventor: Jean-Charles Delplace, Longueil Sainte Marie (FR)

(21) Appl. No.: 14/448,213

(22) Filed: Jul. 31, 2014

(51) Int. Cl. G06K 7/10; B66F 17/00; G01S 19/13; B66C 13/16

(52) U.S. Cl. CPC G06K 7/10366; B66C 13/16; B66F 17/003; G01S 19/13

(57) ABSTRACT

Methods and systems are disclosed for identifying and locating an object in an environment. Identification data for an object is received from an identity sensor, the data received at a central computer system. Location data is received from a lifting device at the central computer system. Load data is received at the central computer system that the object has been loaded onto the lifting device. A location of the object is tracked based on the identification data, the location data, and the load data for the object at the central computer system.

### BACKGROUND

Lifting devices, such as cranes, are employed to hoist or lift objects to great heights. The lifting device may be employed at location such as a construction site. The construction site may have many different objects and types of objects or assets associated with the construction type such as equipment, beams, lumber, building material, etc. The objects may or may not be moved by the lifting device. The crane may swivel or pivot about a pivot point to allow the crane to lift and move objects into position. The identity of the object being moved by the lifting device may not be known. Tracking the location of the objects or assets may be valuable to the activities that are taking place at the constructions site.

### BRIEF DESCRIPTION OF THE DRAWINGS

The accompanying drawings, which are incorporated in and form a part of this application, illustrate and serve to explain the principles of embodiments in conjunction with the description. Unless noted, the drawings referred to this description should be understood as not being drawn to scale.

FIG. 1A is a block diagram of a tower crane system in accordance with embodiments of the present technology.

FIG. 1B is a block diagram of a crane system in accordance with embodiments of the present technology.

FIG. 2 is a block diagram of an environment with a crane in accordance with embodiments of the present technology.

FIG. 3 is a flowchart of a method for identifying and locating an object in an environment in accordance with embodiments of the present technology.

FIG. 4 is a block diagram of an example computer system upon which embodiments of the present technology may be implemented.

FIG. 5 is a block diagram of an example global navigation satellite system (GNSS) receiver which may be used in accordance with embodiments of the present technology.

### DESCRIPTION OF EMBODIMENTS

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

Unless specifically stated otherwise as apparent from the following discussions, it is appreciated that throughout the present description of embodiments, discussions utilizing terms such as “receiving”, “associating”, “logging”, “tracking”, or the like, often refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, mobile communication devices.

### Overview

Embodiments described herein are for identifying an object or asset and its location in an environment. The identifying may be for the purposes of inventory, tracking, job site planning, and lift plan scheduling as well as other purposes. One such environment may be a construction site or job site where a building, road, or other structure is under some type of construction. It should be appreciated that the present technology is not limited to a construction site but may operate in and be useful in any environment where it is valuable to identify and track objects or assets. The construction site may include more than one area or zone such as a staging area or a construction zone. The present technology may also be useful to identify and track large objects that need to be moved or installed via equipment such as a lifting device. The present technology may be used with a lifting device such as a crane or forklift. It should also be appreciated that the present technology may be implemented with a variety of cranes including, but not limited to, a tower crane, a luffing crane, a level luffing crane, a fixed crane, a mobile crane, a self-erecting crane, a crawler crane, and a telescopic crane.

The object or asset may be associated with the construction site and may be equipment that is used at the construction site or may be building materials that are to be installed in the structure being constructed such as lumber, steel, beams, concrete, rebar, glass, drywall, appliances, or any other type of material. Techniques have been developed to identify and/or track objects on a construction site. For example, radio frequency identification (RFID) chips may be used to track and/or identify an object as it is moved around the construction site. The construction site may employ one or more passive RFID readers to detect the chips. A drawback to this solution is that construction site are often large and an RFID reader may have a limited range such as 30 feet. Therefore, the RFID readers either do not read and/or locate all of the objects on the constructions site or a great number of RFID readers are required whose range may or may not cover every space or area of the construction site. Thus, the location of some objects is always unknown.

The present technology employs location sensors on the lifting device that are employed to track the location of the lifting device. For example, the lifting device may have one or more of the following: global positioning system (GPS) satellite sensors, global navigation satellite system (GNSS) sensors or receivers, GNSS antenna, Genesis GPS, mechanical sensor, or optical sensors. Additionally, the location of the crane may be fixed and known to a central computer system. The location sensors may be able to track the location crane itself as well as different components of the crane or the location of the object lifted by the crane. For example, the crane may have more than one location sensor that is used to determine the overall location of the crane as well as the location of the boom, trolley, hook, etc. The location sensors may also be employed to determine the pointing angle of the crane including swing arm location, angle, height, etc.

In one embodiment, the lifting device is able to pick up an object, such as a beam, and move the object from one location to another on the job site. In one embodiment, upon lifting the object the object is identified. This may be accomplished using more than one technique. For example, a rigger may be a construction worker that works closely with the crane operator and is responsible for rigging an object to be lifted by the crane. The rigger may employ a handheld device such as a mobile computer, a smart phone, or other device that is able to communicate with a central computer system. The handheld device may be used by the rigger to identify the object. The handheld device may have an RFID detector that this able to detect an RFID chip coupled with or associated with the object. The RFID chip may have information about the identity of the object as well as other information such as characteristics of the object or installation requirements for the object. The RFID chip may point the handheld device to a database for more information. The rigger may then employ the RFID detector with the handheld device to identify the object. In one embodiment, the RFID detector and chips are only used to identify an object and are not used to determine the objects location.

Another technique identifying the object may be for the rigger to use the handheld device to read a bar code associated with the object. The handheld device is then able to identify the object using a database of information associated with the bar code. The database may also have other information about the object similar to the other information described above for the RFID chip.

In one embodiment, the identity data or other data regarding the object may be displayed to the rigger, the crane operator, job foreman, or other personnel. The opportunity may then be given for the rigger or other person to verify the data. The verification may simply be the rigger visually inspecting the object to ensure that the data regarding the object is accurate. The rigger or other person may also be given the opportunity to supplement, modify, or change the information received from an RFID chip or bar code. Such changes may be logged with information identifying the person who made the changes.

Thus the handheld device may be used to automatically and electronically identify the object. The electronic identification can then be easily transmitted and recorded. The present technology is not limited to identifying the object with an RFID chip or bar code but may employ other means for automatically identifying the object to be lifted such as a Quick Response (QR) code, a three dimensional bar code, Universal Product Code (UPC), etc. The object may also be visually identified by the rigger who then manually enters the identification data into the handheld device. The handheld device may assist the rigger with an interface that provides options such as dropdown menus that may limit the options for what type of data the rigger may enter. The handheld device is then used to transmit the identify data and other data about the object to the central computer system. The data may also be transmitted to a device associated with the crane operator. In one embodiment, the identification of the object and transmission of the data may all occur automatically without any intervention from the rigger or other user. For example, the rigger may only be required to hold or carry the handheld device. Alternatively, the rigger may be required to interact with the handheld device to notify the handheld device that an object is to be identified and the data transmitted.

In one embodiment, the object is automatically identified by a sensor couple with or associated with the lifting device. The sensor may be located one the hook or trolley or other component of the crane. In one embodiment, such a sensor is an RFID detector or reader. The sensor associated with the lifting device can then be used to automatically detect and identify the object and transmit data without any human intervention. The lifting device may employ other sensors to determine data or information about the object being lifted such as the weight of the object. This data may also be transmitted to the central computer system.

In one embodiment, once the lifting device lifts, picks up, or loads an object then it is logged as load data that the object was picked up and this data is sent to the central computer system. The location data generated by the lifting device and its components is also sent to the central computer system and is used to determine where the object was lifted and where it is located it was lifted. Thus, the location sensors associated with the lifting device may send location information to the central computer system more than once during a lift.

The central computer system is able to receive the identity data or information, the other data about the object, the load data, and the plurality of location about the object and the lifting device. Then central computer system may then be employed to track the inventory of the environment or construction site including the identity of the objects or assets and their locations. The central computer system may also track when and where a particular object was installed in a structure based on the information collected. The central computer system may be a Building Information Modeling (BIM) system or associated with a BIM.

### Asset Location and Tracking

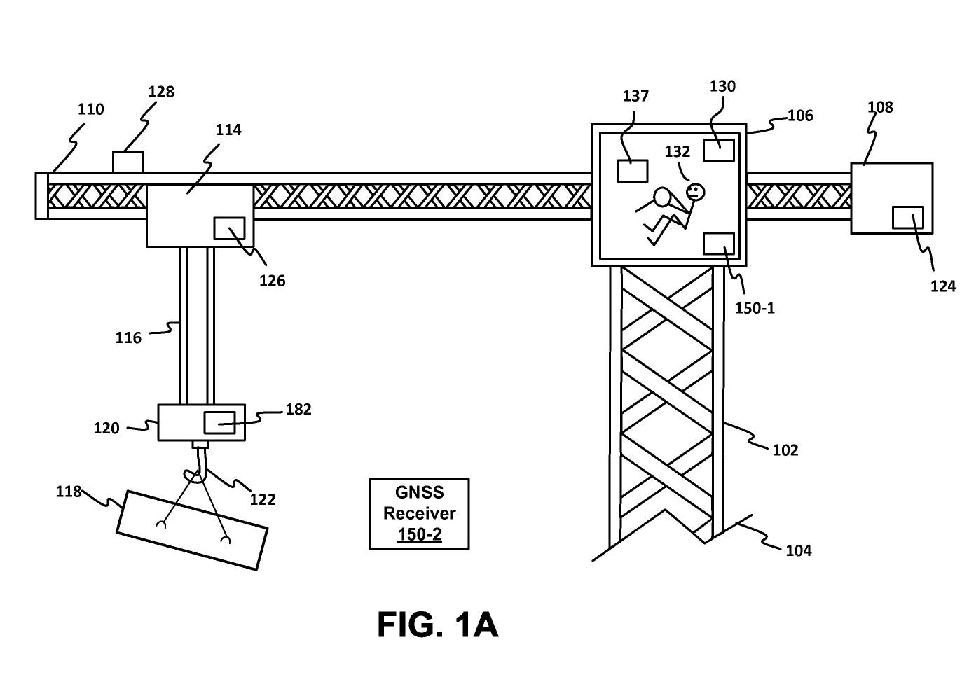

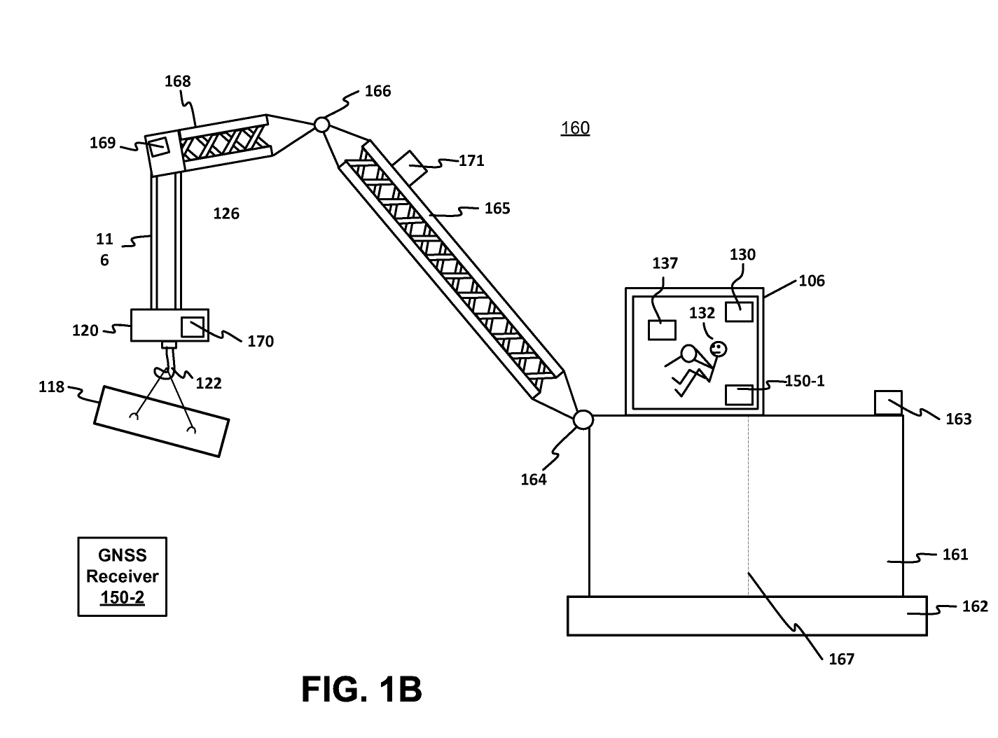

With reference now to FIG. 1A, an illustration of a side view of a tower crane 100 is presented, according to various embodiments. Tower crane 100 may also be referred to as a horizontal crane.

Tower crane 100 includes a base 104, a mast 102 and a working arm (e.g., jib) 110. The mast 102 may be fixed to the base 104 or may be rotatable about base 104. The base 104 may be bolted to a concrete pad that supports the crane or may be mounted to a moveable platform. In one embodiment, the operator 132 is located in a cab 106 which includes a user interface 137.

Tower crane 100 also includes a trolley 114 which is moveable back and forth on working arm 110 between the cab 106 and the end of the working arm 110. A cable 116 couples a hook 122 and hook block 120 to trolley 114. A counterweight 108 is on the opposite side of the working arm 110 as the trolley 114 to balance the weight of the crane components and the object being lifted, referred to hereinafter as object 118.

Tower crane 100 also includes location sensors 124, 126, 128, and 130 which are capable of determining the location of tower crane 100, the pointing angle of tower crane 100, or the location of a single component of tower crane 100. The location sensors 124, 126, 128, and 130 may be employed to determine the location of object 118 once it is loaded onto tower crane 100 and the location of object 118 after it is unloaded from tower crane 100. It should be appreciated that tower crane 100 may employ only one location sensor or any number of location sensors to determine a location and may employ more or less locations sensors than what is depicted by FIG. 1A. Alternatively, the location of tower crane 100 may be stationary and known to a central computer system.

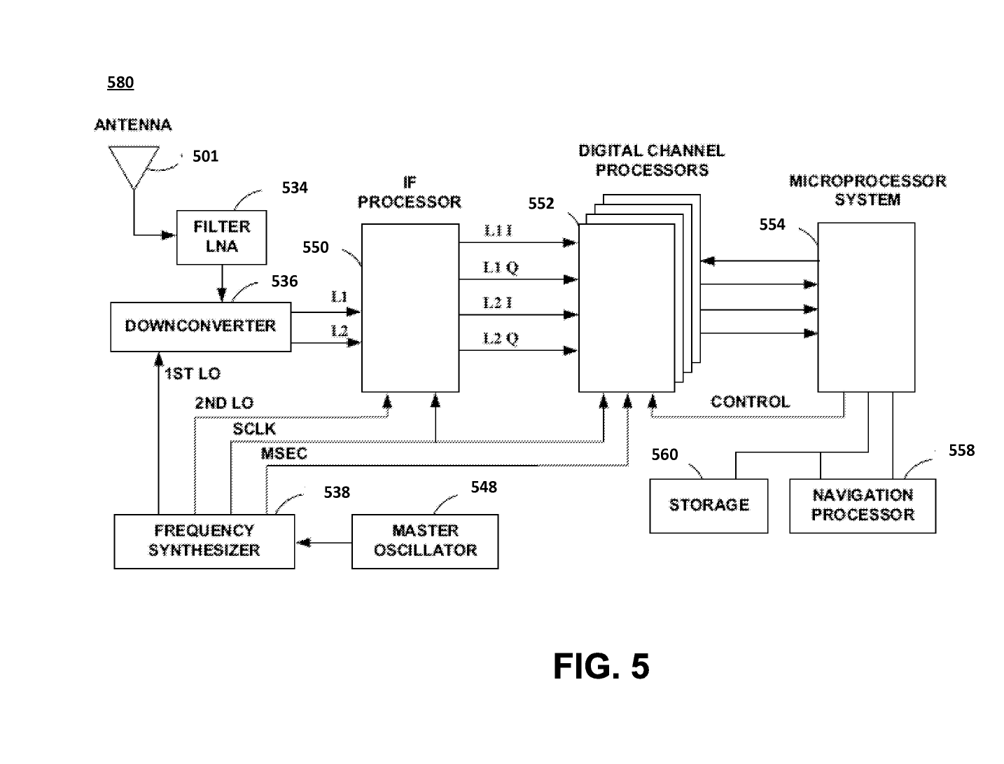

In one embodiment, location sensors 124, 126, 128, and 130 are GNSS receiver antennas each capable of receiving signals from one or more global positioning system (GPS) satellites and/or other positioning satellites, as is described in greater detail in reference to FIG. 5. Each of GNSS receiver antennas are connected to, coupled with, or otherwise in communication with a GNSS receiver. In one embodiment, the GNSS receiver (e.g., GNSS receiver 150-1) may be connected or coupled to tower crane 100. For example, any of GNSS receiver antennas may also include a separate receiver. In one embodiment, the present technology makes use of only one GNSS receiver antenna and one GNSS receiver. In one embodiment, the present technology makes use of a plurality of GNSS receiver antennas in communication with only a single GNSS receiver (e.g., GNSS receiver 150-1 or 150-2). In one embodiment, the present technology makes use of a plurality of GNSS receiver antennas in communication with a plurality of GNSS receivers. In one embodiment, the GNSS receiver (e.g., GNSS receiver 150-2) is located remote to tower crane 100 and is in communication with the GNSS receiver antenna/antennae on the crane via a coaxial cable and/or a wireless communication link.

It should be appreciated that location sensors 124, 126, 128, and 130 may be other types of location sensors such as mechanical or optical. A mechanical or optical sensor may have electronic or digital components that are able to transmit or send location data to a central computer system. The mechanical sensors may operate to determine a swing arm location, angle, height, etc. The mechanical sensors may be used on any component of the crane including the swing arm, the trolley, the hook, etc.

In one embodiment, a single location sensor, such as location sensor 128, is employed to determine a pointing angle of a crane. The single location sensor collects data from at least three positions as the tower crane pivots the arm. The three locations then form a circle with the pivot at the center. Once the pivot point is known, the pointing angle of the crane can be determined using the pivot point and the current location of the single location sensor. A second sensor may then be required to determine the height of the object that is lifted. The single location sensor may be GNSS antenna and the second sensor may be a mechanical sensor.

A GNSS receiver antenna may be disposed along a point of a boom assembly of tower crane 100. The boom assembly may be comprised of cab 106, counterweight 108, working arm 110, and trolley 114.

As depicted in FIG. 1A, a location sensor, such as a GNSS receiver antenna/antennae, may be located at various points on tower crane 100. Location sensor 124 is located on or part of counterweight 108. Location sensor 126 is located on or part of trolley 114. Location sensor 128 is depicted as located on or part of working arm 110. Location sensor 130 is depicted as located on or part of cab 106. A location sensor may also be located on or part of the pivot point of tower crane 100. Hook block 120 and/or hook 122 may also be coupled with a location sensor. It should be appreciated that GNSS antennae and receivers may have errors in determining exact geographic location. Such errors may be overcome using various techniques. The error may be described in statistical terms as an error ellipsoid. The error ellipsoid defines a three-dimensional region which is expected to contain the actual position of the antenna with a given level of confidence. When the distance between the pivot point and the GNSS receiver antenna are much greater than the size of the error ellipsoid, the error in determining the actual pointing angle of the working arm of the crane is reduced.

In one embodiment, the present technology may determine locations in a local coordinate system unique to the construction site or environment. In one embodiment, the present technology may determine locations in an absolute coordinate system that applies to the whole Earth such as the coordinate system used by the Genesis system. The locations may be determined at the location sensors such as the GNSS receiver, or the location sensors may just send raw data to the central computer system where the location is determined based on the raw data.

In one embodiment, sensor 182 is load sensor that is able to detect that tower crane 100 has picked up a load such as object 118. Sensor 182 is depicted as being coupled with or located on hook block 120. However, sensor 183 may be located on another part or component of tower crane 100 such as hook 122 or trolley 114. In one embodiment, sensor 182 is an ID sensor configured to automatically identify object 118. For example, object 118 may have an RFID chip and sensor 182 is an RFID detector or reader that can receive data from the RFID chip used to identify what type of object or material object 118 is. The data on the RFID chip may have data such as a model number, serial number, product name, characteristics of the product such as weight and dimensional, installation information, technical specifications, date of manufacture, point of origin, manufacturer name, etc. The RFID chip may also contain data that points sensor 182 to a database that comprises more data about object 118. In one embodiment, sensor 182 will not identify object 118 until it has feedback that object 118 has been loaded onto tower crane 100. In one embodiment, the load sensor triggers the locations sensors of tower crane 100 to send location data to the central computer system at the time the object is loaded on the crane and/or at the time the object is unloaded from the crane.

It should be appreciated that the various sensors of tower crane 100 such as location sensors, load sensors, or ID sensors may transmit or send data directly to a central computer system or may send data to a computer system coupled with and associated with tower crane 100 which then relays the data to the central computer system. Such transmissions may be sent over data cables or wireless connections such as Wifi, Near Field Communication (NFC), Bluetooth, cellular networks, etc.

With reference now to FIG. 1B, an illustration of a side view of crane 160 is presented, according to various embodiments. Crane 160 may also be referred to as a luffer crane or a level luffing crane. Crane 160 may comprise some of the components described for tower crane 100 of FIG. 1A.

Base 161 is a base or housing for components of crane 160 such as motors, electrical components, hydraulics, etc. In one embodiment, structure 162 comprises wheels, tracks, or other mechanics that allow for the mobility of crane 160. In one embodiment, structure 162 comprises outriggers that can extend or retract and are used for the stability of crane 160. In one embodiment, structure 162 is a platform for a stationary crane. It should be appreciated that base 161 is able to rotate, swivel, or pivot relative to structure 162 along axis 167. Location sensor 163 may be disposed on top of base 161 or may be disposed inside of base 161. Location sensor 163 will move and rotate with base 161 about axis 167.

Pivot point 164 allows for lattice boom 165 to pivot with respect to base 161. In this manner, lattice boom 165 can point in different directions and change angle of pivot point 166. Pivot point 166 allows for jib 168 to pivot and change position with respect to lattice boom 165 and base 161. A location sensor may be attached to or coupled with any component of crane 160. For example, pivot points 164 and 166 may have a GNSS receiver antenna coupled to them. Location sensors 130, 163, 169, 170, and 171 depict various locations a location sensor may be located.

It should also be appreciated that the present technology may be implemented with a variety of cranes including, but not limited to, a tower crane, a luffing crane, a level luffing crane, a fixed crane, a mobile crane, a self-erecting crane, a crawler crane, and a telescopic crane.

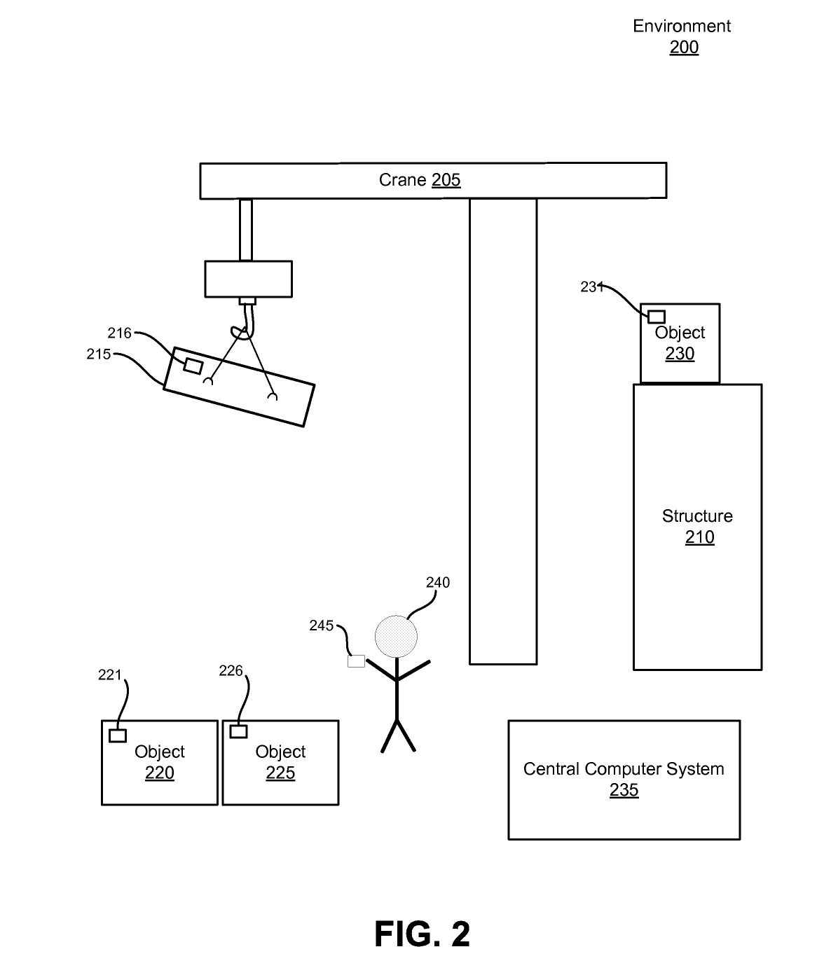

With reference now to FIG. 2, an illustration of environment 200, in accordance with embodiments of the present technology. Environment 200 depicts crane 205 which comprises the features and components of the cranes described in FIGS. 1A and 1B. It should be appreciated that crane 205 may comprises location sensors, load sensors, and/or ID sensors in accordance with embodiments of the present technology. Environment 200 may be a construction site, job site or other environment where large and heavy objects are lifted and moved by lifting devices such as crane 205. Crane 205 is capable of moving objects such as objects 215, 220, 225, and 230. Objects 215, 220, 225, and 230 may be building material or equipment used in the construction of structure 210. Structure 210 may be a building such as a sky scraper, office tower, house, bridge, overpass, road, etc. Objects 220 and 225 are depicts as being in a staging area where they have been delivered to be used in the construction environment. Object 215 is depicted as being lifted by crane 205. Object 230 is depicted as being delivered by crane 205 from the staging area to structure 210. Object 230 may already be installed in structure 210 or may be waiting to be installed in structure 210. Objects 215, 220, 225, and 230 may be different types of building materials or may be the same type.

Objects 215, 220, 225, and 230 are each coupled with or otherwise associated with identifiers 216, 221, 226, and 231 respectively. Identifiers 216, 221, 226, and 231 comprise information or data about the identity and characteristics of their respective objects. The data on the identifier may identify the object. This data may simply be written or inscribed on the object or a label or may be stored on an RFID chip or may be coded using bar code, quick response (QR) code, or other code. The identifier may contain the data itself or may point a user or device to a database where the data is stored. The data, or other data, may include a model number, serial number, product name, characteristics of the product such as size, shape, weight, center of gravity, rigging or equipment needed to lift the object, where the object needs to be moved to on the job site, and other characteristics that may assist a crane operator or job site manager in planning and executing the lift of the identified object, installation information, technical specifications, date of manufacture, point of origin, manufacturer name, etc.

Environment 200 depicts rigger 240. Rigger 240 is a person associated with the job site who typically works closely with the operator of crane 205. However, rigger 240 as depicted in environment 200 may represent any person or user associated with the present technology. Rigger 240 may be responsible for ensuring that an object is properly loaded or rigged for loading onto crane 205 for lifting. Rigger 240 is depicted as carrying handheld device 245 which is an electronic device capable of sending electronic data to central computer system 235. In one embodiment, handheld device 245 is a mobile computer system, a smart phone, a tablet computer, or other mobile device. Handheld device 245 may have output means such as a display and/speakers and input means such as a keyboard, touchscreen, microphone, RFID reader, camera, bar code scanner, bar code reader, etc. Handheld device 245 may comprise a battery for power and may send data over a wireless connection such as Wifi, Near Field Communication (NFC), Bluetooth, cellular networks, etc. Handheld device 245 may be an off the shelf device that may have components added to it or may be a specific purpose device built for the present technology.

Handheld device 245 may also comprise communication components that allow rigger 240 to communicate verbally or otherwise with the operator of crane 205 as well as other personnel such as a job foreman. In one embodiment, handheld device 245 displays a lift plan to rigger 240 that is a schedule of what objects are to be lifted by crane 205 in what order. Thus rigger 240 knows what object is to be loaded or lifted next. For example, after object 215 is lifted, then the lift plan may inform rigger 240 that object 220 is to be lifted next. Rigger 240 can then identify and prepare or rig object 220 for lifting. Handheld device 245 may assist rigger 240 in identifying object 220 by handheld device 245 scanning, detecting, or otherwise reading identifier 221. After an object is identified, the identification data may be sent to the operator of crane 205, the job foreman, central computer system 235, and/or other places. In one embodiment, after the object is identified by rigger 240, the handheld device 245 may give rigger 240 the opportunity to modify, verify, update, supplement, or otherwise change the identification data. Other personal may also be given the opportunity to change the data such as the operator of crane 205 or the job foreman. The identification data may also comprise the other data regarding the characteristics of the object. In one embodiment, rigger 240 manually enters data regarding the identity or characteristics of the object into handheld device 245 based on data that rigger 240 reads from a label applied to the object or based on a visual identification on the part of the rigger. The sensors associated with handheld device 245 that identify an object may be referred to as identity sensors.

In one embodiment, handheld device 245 may be in communication with the load sensor of crane 205 such that the identification data is not sent to central computer system 235 until object 220 is loaded onto the crane at which point the identification data is sent automatically. This loading may also trigger location data to be sent to the central computer system 235 simultaneously. In one embodiment, the handheld device 245 requires the rigger to authorize the identification information being sent to central computer system 235 such that the rigger 240 may verify that the object has actually be lifted by crane 205.

Central computer system 235 receives location data, load data, sensor data, identification data, etc., from the sensors associated with crane 205 and the data from handheld device 245. Central computer system 235 is then able to track the objects for inventory purposes and other job planning purposes or to create a record for what was done at environment 200. The record may be an installation record. In one embodiment, based on the tracking of the object central computer system 235 may determine that the object being lifted is being lifted out of sequence in accordance with a lift plan for crane 205 and environment 200. The central computer system 235 may then be able create an updated lift plan and send it to the crane operator, rigger 240 and the job foreman. Once the object has been identified, the central computer system 235 may also be able to provide additional information to the rigger, the crane operator and the job foreman to formulate a strategy for lifting the object. Central computer system 235 may receive a plurality of locations for a single object including a first location where the object was initially lifted by crane 205 and a second location where the object was unloaded by the crane. Central computer system 235 may receive location data from location sensors that are not located directly on the object. However the central computer system 235 may be able to infer the actual location of the object based on the knowledge of where the location sensor is located on the crane and where the object is lifted by the crane. For example, central computer system 235 may receive location data from a location sensor located on a trolley of crane 205 as well as height data from the pulley system used to lift the object via the hook on crane 205. The combination of this data is then used to infer exactly where the object is located even though the object does not have a location sensor on it.

It should be appreciated that central computer system 235 maybe located at environment 200 or located anywhere else in the world. Central computer system 235 may be more than one computer system and may have some components located in environment 200 and other located elsewhere. In one embodiment, central computer system 235 is a Building Information Modeling (BIM) system. In one embodiment, central computer system 235 is associated with a BIM and is able to pull information from the BIM.

It should be appreciated that while FIGS. 1A, 1B, and 2 depicted cranes, the present technology may also be practiced using other lifting devices such as forklifts. In accordance with the present technology a forklift would have location sensors to generate location information about an object and possibly load sensors to generate data regarding when the object was loaded and unloaded from the forklift and possibly ID sensors to identify the object being loaded. The forklift may also be used in conjunction with a rigger and a handheld device.

### Operations

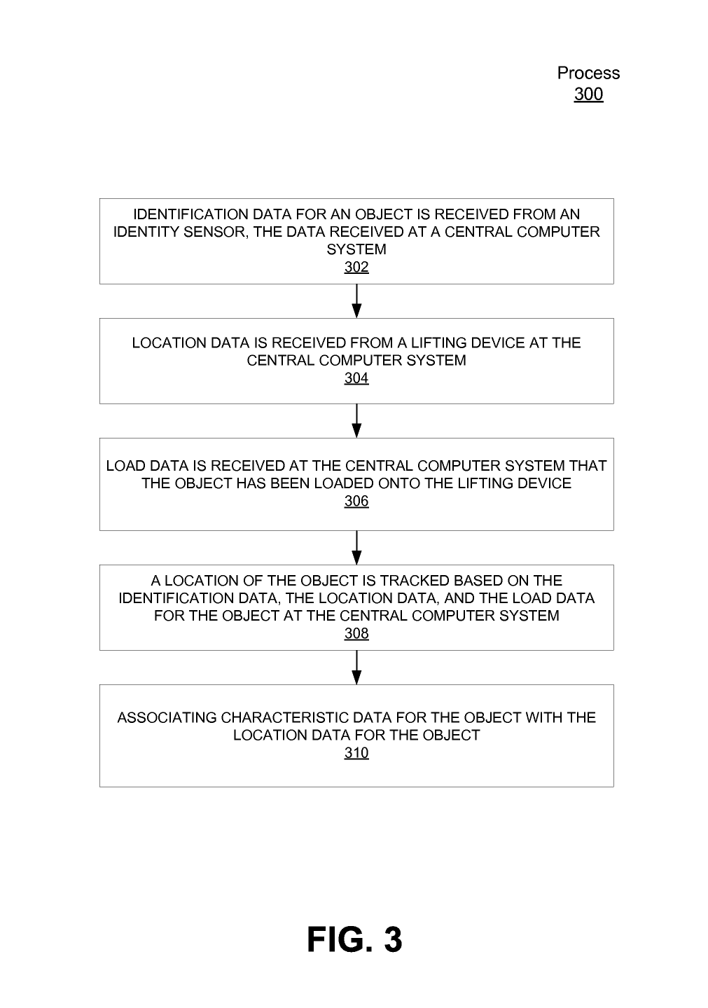

With reference to FIG. 3, process 300 is a process for identifying and locating an object in an environment. In one embodiment, process 300 is computer implemented methods that are carried out by processors and electrical components under the control of computer-usable and computer executable instructions. The computer-usable and computer executable instructions reside, for example, in data storage features such as computer-usable volatile and non-volatile memory. However, the computer-usable and computer executable instructions may reside in any type of non-transitory computer-usable storage medium that can be read by a computer. In one embodiment, process 300 is performed by the components of FIG. 1A, 1B, 2, 4, or 5. In one embodiment, the methods may reside in a computer-usable storage medium having instructions embodied therein that when executed cause a computer system to perform the method.

At 302, identification data for an object is received from an identity sensor, the data received at a central computer system. The identity sensor may be an RFID detector or reader, a bar code scanner, a bar code reader, a QR scanner or camera, or other identifying sensor. The identity sensor may be coupled with or associated with a handheld device such as handheld device 245 of FIG. 2. The identity sensor may also be part of the lifting device.

At 304, location data is received from a lifting device at the central computer system. In one embodiment, the lifting device is a crane, as depicted in FIGS. 1A, 1B, and 2, or a forklift. The location data may be from a location sensor associated with the lifting device and may be a GNSS sensor, a mechanical sensor, or other sensor. The location of the lifting device may be fixed and known to the central computer system. The location data may be in the context of a local coordinate system or an absolute coordinate system.

At 306, load data is received at the central computer system that the object has been loaded onto the lifting device. The load data may be generated by a load sensor associated with the lifting device. The load data may trigger when the location information is sent to the central computer system and the load system may trigger such information to be sent at the time the object is loaded and again when unloaded from the lifting device.

At 308, a location of the object is tracked based on the identification data, the location data, and the load data for the object at the central computer system. The tracking is used for many purposes including, creating or changing a lift plan, installation records, inventory, and other purposes. The central computer system may be a BIM or associated with a BIM.

At 310, characteristic data for the object is associated with the location data for the object. The characteristic data may be obtained once the object is identified and comprises additional information about the object.

### Kalman Filtering

Embodiments of the present technology may include Kalman filtering processes to filter GNSS data in determining locations. The extended Kalman filter and the unscented Kalman filter represent some of the variations to the basic method. Such variations are normal and expected. Generally speaking, Kalman filtering is a basic two-step predictor/corrector modeling process that is commonly used model dynamic systems. A dynamic system will often be described with a series of mathematical models. Models describing satellites in a Global Navigation Satellite System (GNSS) are one example of a dynamic system. Because the position of any satellite and/or the positions of all the satellites in a system constantly and dynamically change and the satellites output a signal that can be measured by a GNSS receiver, Kalman filtering can be used in determining the location of a GNSS antenna.

### Computer System

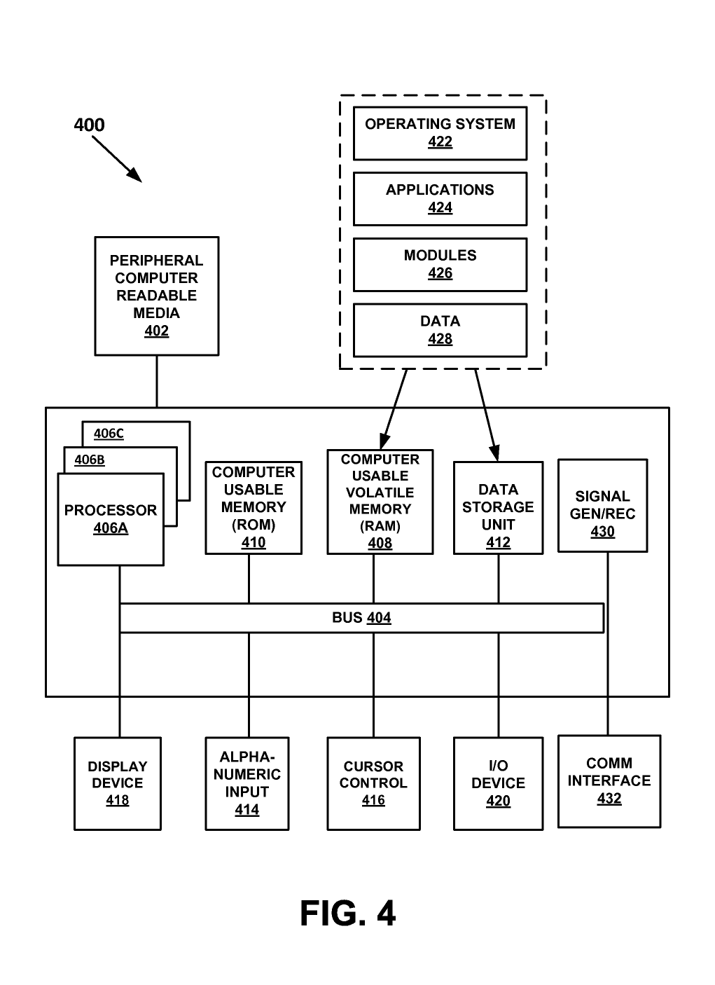

With reference now to FIG. 4, portions of the technology for providing a communication composed of computer-readable and computer-executable instructions that reside, for example, in non-transitory computer-usable storage media of a computer system. That is, FIG. 4 illustrates one example of a type of computer that can be used to implement embodiments of the present technology such as handheld device 245 or central computer system 235 of FIG. 2. FIG. 4 represents a system or components that may be used in conjunction with aspects of the present technology. In one embodiment, some or all of the components of FIGS. 1A, 1B, and 2 may be combined with some or all of the components of FIG. 4 to practice the present technology.

FIG. 4 illustrates an example computer system 400 used in accordance with embodiments of the present technology. It is appreciated that computer system 400 of FIG. 4 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 4, computer system 400 of FIG. 4 is well adapted to having peripheral computer readable media 402 such as, for example, a floppy disk, a compact disc, and the like coupled thereto.

Computer system 400 of FIG. 4 includes an address/data bus 404 for communicating information, and a processor 406A coupled to bus 404 for processing information and instructions. As depicted in FIG. 4, computer system 400 is also well suited to a multi-processor environment in which a plurality of processors 406A, 406B, and 406C are present. Conversely, computer system 400 is also well suited to having a single processor such as, for example, processor 406A. Processors 406A, 406B, and 406C may be any of various types of microprocessors. Computer system 400 also includes data storage features such as a computer-usable volatile memory 408, e.g. random access memory (RAM), coupled to bus 404 for storing information and instructions for processors 406A, 406B, and 406C.

Computer system 400 also includes computer-usable non-volatile memory 410, e.g. read only memory (ROM), coupled to bus 404 for storing static information and instructions for processors 406A, 406B, and 406C. Also present in computer system 400 is a data storage unit 412 (e.g., a magnetic or optical disk and disk drive) coupled to bus 404 for storing information and instructions. Computer system 400 also includes an optional alpha-numeric input device 414 including alphanumeric and function keys coupled to bus 404 for communicating information and command selections to processor 406A or processors 406A, 406B, and 406C. Computer system 400 also includes an optional cursor control device 416 coupled to bus 404 for communicating user input information and command selections to processor 406A or processors 406A, 406B, and 406C. Computer system 400 of the present embodiment also includes an optional display device 418 coupled to bus 404 for displaying information.

Referring still to FIG. 4, optional display device 418 of FIG. 4 may be a liquid crystal device, cathode ray tube, plasma display device, light emitting diode (LED) light-bar, or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

Computer system 400 is also well suited to having a cursor directed by other means such as, for example, voice commands. Computer system 400 also includes an I/O device 420 for coupling computer system 400 with external entities. For example, in one embodiment, I/O device 420 is a modem for enabling wired or wireless communications between computer system 400 and an external network such as, but not limited to, the Internet. A more detailed discussion of the present technology is found below.

Referring still to FIG. 4, various other components are depicted for computer system 400. Specifically, when present, an operating system 422, applications 424, modules 426, and data 428 are shown as typically residing in one or some combination of computer-usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. The present technology may be applied to one or more elements of described computer system 400.

Computer system 400 also includes one or more signal generating and receiving device(s) 430 coupled with bus 404 for enabling system 400 to interface with other electronic devices and computer systems. Signal generating and receiving device(s) 430 of the present embodiment may include wired serial adaptors, modems, and network adaptors, wireless modems, and wireless network adaptors, and other such communication technology. The signal generating and receiving device(s) 430 may work in conjunction with one or more communication interface(s) 432 for coupling information to and/or from computer system 400. Communication interface 432 may include a serial port, parallel port, Universal Serial Bus (USB), Ethernet port, antenna, or other input/output interface. Communication interface 432 may physically, electrically, optically, or wirelessly (e.g. via radio frequency) couple computer system 400 with another device, such as a cellular telephone, radio, or computer system.

The computer system 400 is only one example of a suitable computing environment and is not intended to suggest any limitation as to the scope of use or functionality of the present technology. Neither should the computer system 400 be interpreted as having any dependency or requirement relating to any one or combination of components illustrated in the example computer system 400.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

### GNSS Receiver

With reference now to FIG. 5, a block diagram is shown of an embodiment of an example GNSS receiver which may be used in accordance with various embodiments described herein. In particular, FIG. 5 illustrates a block diagram of a GNSS receiver in the form of a general purpose GPS receiver 580 capable of demodulation of the L1 and/or L2 signal(s) received from one or more GPS satellites. For the purposes of the following discussion, the demodulation of L1 and/or L2 signals is discussed. It is noted that demodulation of the L2 signal(s) is typically performed by “high precision” GNSS receivers such as those used in the military and some civilian applications. Typically, the “consumer” grade GNSS receivers do not access the L2 signal(s). Further, although L1 and L2 signals are described, they should not be construed as a limitation to the signal type; instead, the use of the L1 and L2 signal(s) is provided merely for clarity in the present discussion.

Although an embodiment of a GNSS receiver and operation with respect to GPS is described herein, the technology is well suited for use with numerous other GNSS signal(s) including, but not limited to, GPS signal(s), Glonass signal(s), Galileo signal(s), and BeiDou signal(s).

The technology is also well suited for use with regional navigation satellite system signal(s) including, but not limited to, Omnistar signal(s), StarFire signal(s), Centerpoint signal(s), Doppler orbitography and radio-positioning integrated by satellite (DORIS) signal(s), Indian regional navigational satellite system (IRNSS) signal(s), quasi-zenith satellite system (QZSS) signal(s), and the like.

Moreover, the technology may utilize various satellite based augmentation system (SBAS) signal(s) such as, but not limited to, wide area augmentation system (WAAS) signal(s), European geostationary navigation overlay service (EGNOS) signal(s), multi-functional satellite augmentation system (MSAS) signal(s), GPS aided geo augmented navigation (GAGAN) signal(s), and the like.

In addition, the technology may further utilize ground based augmentation systems (GBAS) signal(s) such as, but not limited to, local area augmentation system (LAAS) signal(s), ground-based regional augmentation system (GRAS) signals, Differential GPS (DGPS) signal(s), continuously operating reference stations (CORS) signal(s), and the like.

Although the example herein utilizes GPS, the present technology may utilize any of the plurality of different navigation system signal(s). Moreover, the present technology may utilize two or more different types of navigation system signal(s) to generate location information. Thus, although a GPS operational example is provided herein it is merely for purposes of clarity.

In one embodiment, the present technology may be utilized by GNSS receivers which access the L1 signals alone, or in combination with the L2 signal(s). A more detailed discussion of the function of a receiver such as GPS receiver 580 can be found in U.S. Pat. No. 5,621,426. U.S. Pat. No. 5,621,426, by Gary R. Lennen, entitled “Optimized processing of signals for enhanced cross-correlation in a satellite positioning system receiver,” incorporated by reference which includes a GPS receiver very similar to GPS receiver 580 of FIG. 5.

In FIG. 5, received L1 and L2 signal is generated by at least one GPS satellite. Each GPS satellite generates different signal L1 and L2 signals and they are processed by different digital channel processors 552 which operate in the same way as one another. FIG. 5 shows GPS signals (L1=1575.42 MHz, L2=1227.60 MHz) entering GPS receiver 580 through a dual frequency antenna 501. Antenna 501 may be a magnetically mountable model commercially available from Trimble® Navigation of Sunnyvale, Calif., 94085. Master oscillator 548 provides the reference oscillator which drives all other clocks in the system. Frequency synthesizer 538 takes the output of master oscillator 548 and generates important clock and local oscillator frequencies used throughout the system. For example, in one embodiment frequency synthesizer 538 generates several timing signals such as a 1st LO1 (local oscillator) signal 1400 MHz, a 2nd LO2 signal 175 MHz, a (sampling clock) SCLK signal 25 MHz, and a MSEC (millisecond) signal used by the system as a measurement of local reference time.

A filter/LNA (Low Noise Amplifier) 534 performs filtering and low noise amplification of both L1 and L2 signals. The noise figure of GPS receiver 580 is dictated by the performance of the filter/LNA combination. The downconverter 536 mixes both L1 and L2 signals in frequency down to approximately 175 MHz and outputs the analogue L1 and L2 signals into an IF (intermediate frequency) processor 30. IF processor 550 takes the analog L1 and L2 signals at approximately 175 MHz and converts them into digitally sampled L1 and L2 inphase (L1 I and L2 I) and quadrature signals (L1 Q and L2 Q) at carrier frequencies 420 KHz for L1 and at 2.6 MHz for L2 signals respectively.

At least one digital channel processor 552 inputs the digitally sampled L1 and L2 inphase and quadrature signals. All digital channel processors 552 are typically identical by design and typically operate on identical input samples. Each digital channel processor 552 is designed to digitally track the L1 and L2 signals produced by one satellite by tracking code and carrier signals and to form code and carrier phase measurements in conjunction with the microprocessor system 554. One digital channel processor 552 is capable of tracking one satellite in both L1 and L2 channels.

Microprocessor system 554 is a general purpose computing device which facilitates tracking and measurements processes, providing pseudorange and carrier phase measurements for a navigation processor 558. In one embodiment, microprocessor system 554 provides signals to control the operation of one or more digital channel processors 552. Navigation processor 558 performs the higher level function of combining measurements in such a way as to produce position, velocity and time information for the differential and surveying functions. Storage 560 is coupled with navigation processor 558 and microprocessor system 554. It is appreciated that storage 560 may comprise a volatile or non-volatile storage such as a RAM or ROM, or some other computer readable memory device or media.

One example of a GPS chipset upon which embodiments of the present technology may be implemented is the Maxwell™ chipset which is commercially available from Trimble® Navigation of Sunnyvale, Calif., 94085.

### Differential GPS

Embodiments described herein can use Differential GPS to determine position information with respect to a jib of the tower crane. Differential GPS (DGPS) utilizes a reference station which is located at a surveyed position to gather data and deduce corrections for the various error contributions which reduce the precision of determining a position fix. For example, as the GNSS signals pass through the ionosphere and troposphere, propagation delays may occur. Other factors which may reduce the precision of determining a position fix may include satellite clock errors, GNSS receiver clock errors, and satellite position errors (ephemeredes).

The reference station receives essentially the same GNSS signals as rovers which may also be operating in the area. However, instead of using the timing signals from the GNSS satellites to calculate its position, it uses its known position to calculate errors in the respective satellite measurements. The reference station satellite errors, or corrections, are then broadcast to rover GNSS equipment working in the vicinity of the reference station. The rover GNSS receiver applies the reference station satellite corrections to its respective satellite measurements and in so doing, removes many systematic satellite and atmospheric errors. As a result, the rover GNSS receiver position estimates are more precisely determined. Alternatively, the reference station corrections may be stored for later retrieval and correction via post-processing techniques.

### Real Time Kinematic System

An improvement to DGPS methods is referred to as Real-time Kinematic (RTK). The present technology employs RTK, however, in one embodiment, the working angle of the crane is determined without using RTK. As in the DGPS method, the RTK method, utilizes a reference station located at determined or surveyed point. The reference station collects data from the same set of satellites in view by the rovers in the area. Measurements of GNSS signal errors taken at the reference station (e.g., dual-frequency code and carrier phase signal errors) and broadcast to one or more rovers working in the area. The rover(s) combine the reference station data with locally collected carrier phase and pseudo-range measurements to estimate carrier-phase ambiguities and precise rover position. The RTK method is different from DGPS methods primarily because RTK is based on precise GNSS carrier phase measurements. DGPS methods are typically based on pseudo-range measurements. The accuracy of DGPS methods is typically decimeter-to meter-level; whereas RTK techniques typically deliver cm-level position accuracy.

RTK rovers are typically limited to operating within 70 km of a single reference station, Atmospheric errors such as ionospheric and tropospheric errors become significant beyond 70 km. “Network RTK” or “Virtual Reference Station” (VRS) techniques have been developed to address some of the limitations of single-reference station RTK methods.

### Network RTK

Network RTK typically uses three or more GNSS reference stations to collect GNSS data and extract spatial and temporal information about the atmospheric and satellite ephemeris errors affecting signals within the network coverage region. Data from all the various reference stations is transmitted to a central processing facility, or control center for Network RTK. Suitable software at the control center processes the reference station data to infer how atmospheric and/or satellite ephemeris errors vary over the region covered by the network. The control center computer then applies a process which interpolates the atmospheric and/or satellite ephemeris errors at any given point within the network coverage area. Synthetic pseudo-range and carrier phase observations for satellites in view are then generated for a “virtual reference station” nearby the rover(s).

The rover is configured to couple a data-capable cellular telephone to its internal signal processing system. The surveyor operating the rover determines that he needs to activate the VRS process and initiates a call to the control center to make a connection with the processing computer. The rover sends its approximate position, based on raw GNSS data from the satellites in view without any corrections, to the control center. Typically, this approximate position is accurate to approximately 4-7 meters. The surveyor then requests a set of “modeled observables” for the specific location of the rover. The control center performs a series of calculations and creates a set of correction models that provide the rover with the means to estimate the ionospheric path delay from each satellite in view from the rover, and to take into account other error contributions for those same satellites at the current instant in time for the rover's location. In other words, the corrections for a specific rover at a specific location are determined on command by the central processor at the control center and a corrected data stream is sent from the control center to the rover. Alternatively, the control center may instead send atmospheric and ephemeris corrections to the rover which then uses that information to determine its position more precisely.

These corrections are now sufficiently precise that the high performance position accuracy standard of 2-3 cm may be determined, in real time, for any arbitrary rover position. Thus the GNSS rover's raw GNSS data fix can be corrected to a degree that makes it behave as if it were a surveyed reference location; hence the terminology “virtual reference station.” An example of a network RTK system which may be utilized in accordance with embodiments described herein is described in U. S. Pat. No. 5,899,957, entitled “Carrier Phase Differential GPS Corrections Network,” by Peter Loomis, assigned to the assignee of the present patent application and incorporated as reference herein in its entirety.

The Virtual Reference Station method extends the allowable distance from any reference station to the rovers. Reference stations may now be located hundreds of kilometers apart, and corrections can be generated for any point within an area surrounded by reference stations.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for identifying and locating an object in an environment, said method comprising:
receiving identification data for an object from an identity sensor, said data received at a central computer system;
receiving location data from a lifting device at said central computer system;
receiving load data at said central computer system that said object has been loaded onto said lifting device; and
tracking a location of said object based on said identification data, said location data, and said load data for said object at said central computer system.

2. The method as recited in claim 1 wherein said lifting device is a crane wherein said crane is selected from the group of cranes consisting of: a tower crane, a luffing crane, a level luffing crane, a fixed crane, a mobile crane, a self-erecting crane, a crawler crane, and a telescopic crane.

3. The method as recited in claim 1 wherein said lifting device is a forklift.

4. The method as recited in claim 1 wherein said identifying sensor is a radio frequency identification (RFID) detector associated with said lifting device that automatically reads an RFID chip coupled with said object once said object is loaded onto said lifting device.

5. The method as recited in claim 1 wherein said identifying sensor is a handheld device associated with a rigger.

6. The method as recited in claim 5 wherein said handheld device generates said identification data by scanning a bar code on said object.

7. The method as recited in claim 5 wherein said handheld device generates said identification data by reading radio frequency identification (RFID) associated with said object.

8. The method as recited in claim 5 wherein said handheld device receives said identification data from a rigger using said handheld device.

9. The method as recited in claim 1, further comprising:
associating characteristic data for said object with said location data for said object.

10. The method as recited in claim 9 wherein said characteristic data for said object is retrieved by said central computer system from a building information modeling (BIM) system.

11. The method as recited in claim 1 wherein said central computer system comprises a building information modeling (BIM) system.

12. The method as recited in claim 1 wherein said location data is generated by a global navigation satellite system (GNSS) antenna and receiver associated with said lifting device.

13. The method as recited in claim 1 wherein a location of said lifting device is known to said central computer system.

14. The method as recited in claim 1 wherein said location data is a location of said object when said object is loaded onto said lifting device.

15. The method as recited in claim 1 wherein said location data is a location of said object after said object is unloaded from said lifting device.

16. The method as recited in claim 1 wherein said lifting device comprises a plurality of location generating devices for generating said location data.

17. The method as recited in claim 1 wherein said location data is generated by mechanical sensors associated with lifting device.

18. The method as recited in claim 1 wherein said location data is for an absolute coordinate system.

19. The method as recited in claim 1 wherein said location data is for a local coordinate system.

20. The method as recited in claim 1 wherein said central computer system updates a lift plan for said lifting device based on said identification data, said location data, and said load data for said object.

21. A computer-usable storage medium having instructions embodied therein that when executed cause a computer system to perform a method for identifying and locating an object in an environment, said method comprising:
receiving identification data for an object from an identity sensor, said data received at a central computer system;
receiving location data from a lifting device at said central computer system;
receiving load data at said central computer system that said object has been loaded onto said lifting device; and
tracking a location of said object based on said identification data, said location data, and said load data for said object at said central computer system.

22. The computer-usable storage medium as recited in claim 21, wherein said identity sensor is a radio frequency identification (RFID) detector associated with said lifting device that automatically reads an RFID chip coupled with said object once said object is loaded onto said lifting device.

23. The computer-usable storage medium as recited in claim 21, wherein said identity sensor is a handheld device associated with a rigger.

24. The computer-usable storage medium as recited in claim 23, wherein said handheld device receives said identification data from a rigger using said handheld device.

25. The computer-usable storage medium as recited in claim 21, wherein said location data is generated by a global navigation satellite system (GNSS) antenna and receiver associated with said lifting device.

26. The computer-usable storage medium as recited in claim 21, wherein said location data is generated by mechanical sensors associated with lifting device.

27. The computer-usable storage medium as recited in claim 21, wherein said central computer system updates a lift plan for said lifting device based on said identification data, said location data, and said load data for said object.

28. A system for identifying and locating an object in an environment, said system comprising:
an object in an environment wherein said object is to be moved by a lifting device; and
a central computer system for receiving identification data, location data, and load data for said object and for tracking a location of said object based on said identification data, said location data, and said load data for said object.

29. The system as recited in claim 28 further comprising:
a handheld device for generating said identification data, wherein said identification data identifies said object.

30. The system as recited in claim 29 wherein said handheld device employs a radio frequency identification (RFID) detector to identify said object.

31. The system as recited in claim 29 wherein said handheld device employs a bar code reader to identify said object.

32. The system as recited in claim 28 further comprising:
said lifting device comprising:
at least one location sensor for generating said location data indicating a location of said object; and
a load sensor for generating said load data indicating that said object has been loaded onto said lifting device.

33. The system as recited in claim 32 wherein said at least one location sensor is a global navigation satellite system (GNSS) antenna.

34. The system as recited in claim 32 wherein said at least one location sensor is a mechanical sensor.

35. The system as recited in claim 28 wherein said lifting device is a crane wherein said crane is selected from the group of cranes consisting of: a tower crane, a luffing crane, a level luffing crane, a fixed crane, a mobile crane, a self-erecting crane, a crawler crane, and a telescopic crane.

36. The system as recited in claim 28 wherein said lifting device is a forklift.
